(19) United States
(12) Patent Application Publication
(10) Pub. No.: US 2013/0088189 A1
(43) Pub. Date: Apr. 11, 2013

(54) Portable charging apparatus

(71) Applicant: Phillip Emerson, Meridian, MS (US)

(72) Inventor: Phillip Emerson, Meridian, MS (US)

(21) Appl. No.: 13/271,187

(22) Filed: Oct. 11, 2011

(51) Int. Cl. H02J 7/00

(52) U.S. Cl. 320/107

(57) ABSTRACT

The present invention is a portable charging apparatus that includes an interior casing, a crank gear disposed on the interior casing, a plurality of alternator wires, an alternator gear that is integral to the crank gear and rotates when the crank gear is rotated generating electrical power and a voltmeter box that is in electrical communication with the alternator gear through the alternator wires. The apparatus also includes a pair of top stabilizer bars, a pair of charge clamps that include a positive charge clamp and a negative charge clamp that transmit generated electrical power from the interior casing to the charge clamps, a pair of bottom stabilizer bars and a crank that is disposed on the front of the interior casing and is integral to the crank gear and is cranked to generate electrical power.

### TECHNICAL FIELD & BACKGROUND

Currently there are limited alternatives to equipment that offers consumers a relatively long-lasting, self-powered option to charging a car battery or electrical equipment. Traditional approaches toward jump starting a vehicle can prove to be both vigorous and erratic for an individual.

The present invention generally relates to a charging apparatus. More specifically, the invention is a portable charging apparatus.

It is an object of the invention to provide a portable charging apparatus that is portable and efficiently starts an automotive battery or electrical equipment.

It is an object of the invention to provide a portable charging apparatus that can hold an electric charge for an indefinite period of time.

It is an object of the invention to provide a portable charging apparatus that has a crank jump that always has a relatively strong charge.

What is really needed is a portable charging apparatus that is portable and efficiently starts an automotive battery that can hold an electric charge for an indefinite and that has a crank jump that always has a relatively strong charge.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of an exposed interior casing of a portable charging apparatus, in accordance with one embodiment of the present invention.

FIG. 1B illustrates a front perspective view of a portable charging apparatus, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

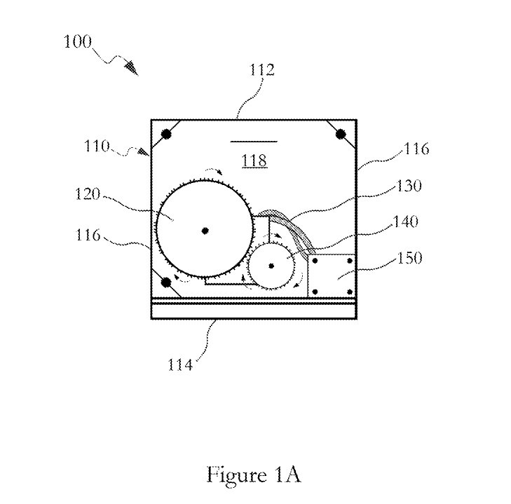

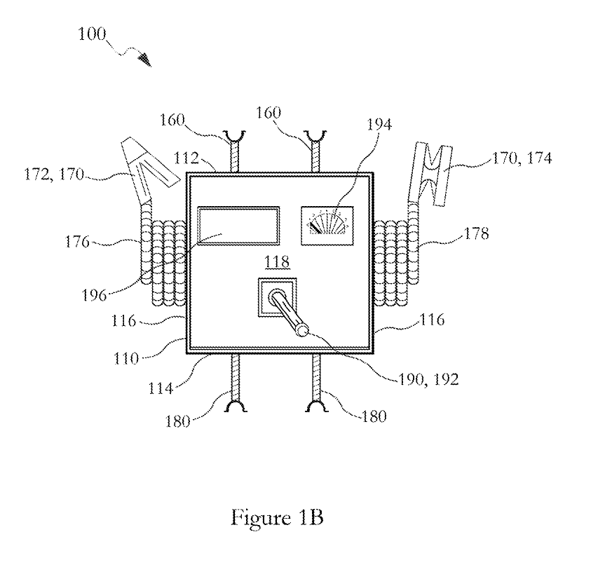

FIG. 1A illustrates a front perspective view of an exposed interior casing 110 of a portable charging apparatus 100, in accordance with one embodiment of the present invention. The portable charging apparatus 100 includes the interior casing 110, a crank gear 120, a plurality of alternator wires 130, an alternator gear 140 and a voltmeter box 150. The interior casing 110 contains all of the interior components of the portable charging apparatus 100 which include the crank gear 120, the plurality of alternator wires 130, the alternator gear 140 and the voltmeter box 150. The interior casing 110 includes a top 112, a bottom 114, a pair of sides 116 and a front 118 and is made of plastic material although the interior casing 110 can be made of any suitable material. The crank gear 120 can be any suitable type of crank gear that is approximately 8 inches in width, although the crank gear 120 can be any suitable dimension or width and be made of any suitable material. The alternator wires 130 are in electrical communication with the alternator gear 140 and the voltmeter box 150 and can be any suitable type of electrical wiring. The alternator gear 140 is integral to the crank gear 120 and rotates when the crank gear 120 is rotated generating electrical power. The alternator gear 140 is approximately 3 inches in width but can be any suitable width. The voltmeter box 150 is in electrical communication with the alternator gear 140 through the alternator wires 130 and can be any suitable voltmeter box type.

FIG. 1B illustrates a front perspective view of a portable charging apparatus 100, in accordance with one embodiment of the present invention. The portable charging apparatus 100 includes all of the components illustrated in FIG. 1A and its description such as the interior casing 110, the crank gear 120, the plurality of alternator wires 130, the alternator gear 140 and the voltmeter box 150.

The portable charging apparatus 100 includes a pair of top stabilizer bars 160, a pair of charge clamps 170, a pair of bottom stabilizer bars 180 and a crank 190. The top stabilizer bars 180 are disposed on the top 112 of the interior casing 110 to stabilize the portable charging apparatus 100 from the top 112 of the interior casing 110 and can be locking stabilizer bars. The charge clamps 170 are insulated and include a positive charge clamp 172 and a negative charge clamp 174. The positive charge clamp 172 is integral to a first charge wire 176 that is disposed on one side 116 of the interior casing 110 and the negative charge clamp 174 that is integral to a second charge wire 178 disposed on the other side 116 of the interior casing 110. Both charge wires 174,176 transmit generated electrical power from the interior casing 110 to the charge clamps 170. The bottom stabilizer bars 180 are disposed on the bottom 118 of the interior casing 110 to stabilize the portable charging apparatus 100 from the bottom 118 of the interior casing 110. The crank 190 is disposed on the front 118 of the interior casing 110 and is integral to the crank gear 120 although the crank 190 can be disposed anywhere on the interior casing 110. The crank 190 is a high intensity manual crank 192 that can be cranked to generate any desired electrical power to be transmitted through the charge clamps 170 and the charge wires 176,178. A volt meter 194 is also disposed on the front 118 of the interior casing 110 that indicates a voltage reading from the volt meter box 150. One or more logo indicia 196 can also be disposed on the front 118 of the interior casing 110 as well for advertising or commercial purposes or other suitable purposes.

The portable charging apparatus includes two full-sized insulated charge clamps and locking stabilizer bars, which make the portable charging apparatus a relatively reliable, rugged, handy charging solution for situations that require a relatively quick electrical charge. The portable charging apparatus incorporates a high intensity manual crank with a fast-acting heavy-duty alternator and crank gears to deliver peak amperage for relatively high performance. The portable charging apparatus also includes a durable, weather resistant plastic enclosure with a volt meter. The portable charging apparatus will benefit consumers who struggle with roadside emergencies and may be readily available in automotive retail stores. The portable charging apparatus requires no recharging and is always ready for automotive jump starting. The design of the portable charging apparatus is well-suited for use in a wide variety of environments and situations that require equipment that need a relatively quick jump-start in a variety of environments including automotive, marine and industrial environments.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A portable charging apparatus, comprising:
an interior casing that includes a top, a bottom, a pair of sides and a front;
a crank gear disposed on said front of interior casing;
a plurality of alternator wires that transmits voltage;
an alternator gear that is integral to said crank gear and rotates when said crank gear is rotated generating electrical power;
a voltmeter box that is in electrical communication with said alternator gear through said alternator wires;
a pair of top stabilizer bars that are disposed on said top of said interior casing to stabilize said portable charging apparatus;
a pair of charge clamps that include a positive charge clamp and a negative charge clamp that are removably disposed on each said side of said interior casing that transmit generated electrical power from said interior casing to said charge clamps;
a pair of bottom stabilizer bars that are disposed on said bottom of said interior casing to stabilize said portable charging apparatus; and
a crank that is disposed on said front of said interior casing and is integral to said crank gear and is cranked to generate any desired electrical power to be transmitted through said charge clamps and said charge wires.

2. The apparatus according to claim 1, wherein said positive charge clamp is integral to a first charge wire that is disposed on one said side of said interior casing.

3. The apparatus according to claim 1, wherein said negative charge clamp is integral to a second charge wire disposed on other said side of said interior casing.

4. The apparatus according to claim 1, wherein said crank is a high intensity manual crank.

5. The apparatus according to claim 1, wherein said apparatus includes a volt meter that is disposed on said front of said interior casing that indicates a voltage reading from said volt meter box.

6. A portable charging apparatus, comprising:
an interior casing that includes a top, a bottom, a pair of sides and a front;
a crank gear disposed on said front of interior casing;
a plurality of alternator wires that transmits voltage;
an alternator gear that is integral to said crank gear and rotates when said crank gear is rotated generating electrical power;
a voltmeter box that is in electrical communication with said alternator gear through said alternator wires;
a pair of top stabilizer bars that are disposed on said top of said interior casing to stabilize said portable charging apparatus;
a pair of charge clamps that include a positive charge clamp and a negative charge clamp that are removably disposed on each said side of said interior casing that transmit generated electrical power from said interior casing to said charge clamps;
a pair of bottom stabilizer bars that are disposed on said bottom of said interior casing to stabilize said portable charging apparatus; and
a crank that is disposed on said front of said interior casing and is integral to said crank gear and is cranked to generate said electrical power to be transmitted through said charge clamps and said charge wires; and
one or more logo indicia that are disposed on said front of said interior casing.

7. The apparatus according to claim 6, wherein said positive charge clamp is integral to a first charge wire that is disposed on one said side of said interior casing.

8. The apparatus according to claim 6, wherein said negative charge clamp is integral to a second charge wire disposed on other said side of said interior casing.

9. The apparatus according to claim 6, wherein said crank is a high intensity manual crank.

10. The apparatus according to claim 6, wherein said apparatus includes a volt meter that is disposed on said front of said interior casing that indicates a voltage reading from said volt meter box.

11. The apparatus according to claim 6, wherein said logo indicia are advertising logo indicia or commercial logo indicia.

12. A portable charging apparatus, comprising:
an interior casing that includes a top, a bottom, a pair of sides and a front;
a crank gear disposed on said front of interior casing;
a plurality of alternator wires that transmits voltage;
an alternator gear that is integral to said crank gear and rotates when said crank gear is rotated generating electrical power;
a voltmeter box that is in electrical communication with said alternator gear through said alternator wires;
a pair of top locking stabilizer bars that are disposed on said top of said interior casing to stabilize said portable charging apparatus;
a pair of insulated charge clamps that include a positive charge clamp and a negative charge clamp that are removably disposed on each said side of said interior casing that transmit generated electrical power from said interior casing to said charge clamps;
a pair of bottom locking stabilizer bars that are disposed on said bottom of said interior casing to stabilize said portable charging apparatus; and
a crank that is disposed on said front of said interior casing and is integral to said crank gear and is cranked to generate said electrical power to be transmitted through said charge clamps and said charge wires; and
one or more logo indicia that are disposed on said front of said interior casing.

13. The apparatus according to claim 12, wherein said interior casing is made of plastic.

14. The apparatus according to claim 12, wherein said crank gear is approximately 8 inches in width.

15. The apparatus according to claim 12, wherein said alternator gear is approximately 3 inches in width.

16. The apparatus according to claim 12, wherein said positive charge clamp is integral to a first charge wire that is disposed on one said side of said interior casing.

17. The apparatus according to claim 12, wherein said negative charge clamp is integral to a second charge wire disposed on other said side of said interior casing.

18. The apparatus according to claim 12, wherein said crank is a high intensity manual crank.

19. The apparatus according to claim 12, wherein said apparatus includes a volt meter that is disposed on said front of said interior casing that indicates a voltage reading from said volt meter box.

20. The apparatus according to claim 12, wherein said logo indicia are advertising logo indicia or commercial logo indicia.
